(19) United States
(12) Patent Application Publication
(10) Pub. No.: US 2022/0410663 A1
(43) Pub. Date: Dec. 29, 2022

(54) THERMAL MANAGEMENT SYSTEM CONTROL METHOD FOR VEHICLE

(71) Applicants: Hyundai Motor Company, Seoul (KR); Kia Corporation, Seoul (KR)

(72) Inventors: Jae Yeon Kim, Hwaseong-si (KR); Wan Je Cho, Hwaseong-si (KR); Yeonho Kim, Seoul (KR); Jeawan Kim, Gwangmyeong-si (KR); SeungRyeol Lee, Hwaseong-si (KR); Seong-Bin Jeong, Hwaseong-si (KR)

(73) Assignees: Hyundai Motor Company, Seoul (KR); Kia Corporation, Seoul (KR)

(21) Appl. No.: 17/545,916

(22) Filed: Dec. 8, 2021

(30) Foreign Application Priority Data
Jun. 23, 2021 (KR) 10-2021-0081384

(51) Int. Cl. B60H 1/32; B60H 1/00

(52) U.S. Cl. CPC B60H 1/321; B60H 1/00278; B60H 1/3227; B60H 1/00392; B60H 2001/00307; B60H 2001/3255; B60H 2001/3272; B60H 2001/3282; B60H 2001/3285

(57) ABSTRACT

A thermal management system control method for a vehicle, may include: (A) a process in which a controller determines whether a pre-cooling mode is selected according to data detected from a data detector before track driving of the vehicle, and operates an air conditioner; (B) a process in which the controller, when the process (A) is completed, operates a battery chiller expansion valve to cool a battery module according to the data detected from the data detector; and (C) a process in which the controller, when the process (B) is completed, determines whether the evaporator is frozen and then thaws the evaporator or controls an evaporator expansion valve, and terminates the control.

### CROSS-REFERENCE TO RELATED APPLICATION

The present application claims priority to Korean Patent Application No. 10-2021-0081384 filed on Jun. 23, 2021, the entire contents of which is incorporated herein for all purposes by this reference.

### BACKGROUND OF THE INVENTION

### Field of the Invention

The present invention relates to a thermal management system control method for a vehicle, and more particularly, to a thermal management system control method for a vehicle which may prevent a rapid temperature rise of a battery module by use of a refrigerant circulating in an air conditioner before track driving of a high performance electric vehicle.

### Description of Related Art

In recent years, an electric vehicle has become popular as a future transporting means, as the environment and energy resources are becoming important issues. The electric vehicle utilizes a battery module in which a plurality of rechargeable cells is formed as one pack as a main power source, and thus no exhaust gas is generated and noise is very low.

Such an electric vehicle is driven by a driving motor which operates through electric power supplied from the battery module. Furthermore, the electric vehicle includes electrical components for controlling and managing the driving motor as well as a plurality of electronic convenience devices and charging the battery module.

Since a large amount of heat is generated in the battery module as well as the electrical components including the driving motor used as a primary power source of the electric vehicle, efficient cooling is required, so efficient temperature management of the electrical components and the battery module may be a very important problem.

Conventionally, separate cooling systems are applied to adjust the temperature of the electrical components and the battery module, but it is necessary to increase capacity of the cooling system according thereto, which leads to space restrictions. Furthermore, when the capacity of the cooling systems is increased, power required for operating the cooling systems is also increased.

Accordingly, it is required to develop technologies for efficiently using waste heat generated from the electrical components, as well as adjusting the temperature of the electrical components and the battery to maximize the energy efficiency while securing the durability of the electrical components and the battery module in the electric vehicle.

On the other hand, recently, high-performance electric vehicles configured for track driving are being developed, and in the track driving that requires higher performance compared with general driving and in which a lot of load is generated, temperature changes of electrical components and battery modules may rapidly occur.

Accordingly, in the electric vehicle configured for track driving, there is a demand for technology development for controlling the temperature of the electrical components and the battery modules during the track driving and for optimizing the track driving.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a thermal management system control method for a vehicle which may prevent a rapid temperature rise of a battery module by use of a refrigerant circulating an air conditioner before track driving of a high performance electric vehicle, and simultaneously, which may secure driving stability by preventing an evaporator from freezing while the air conditioner is in an operation state.

Various aspects of the present invention are directed to providing a thermal management system control method for a vehicle, including: (A) a process in which a controller is configured to determine whether a pre-cooling mode is selected according to data detected from a data detector before track driving of the vehicle, and operates an air conditioner; (B) a process in which the controller, when the process (A) is completed, operates a battery chiller expansion valve to cool a battery module according to the data detected from the data detector; and (C) a process in which the controller, when the process (B) is completed, determines whether the evaporator is frozen and then thaws the evaporator or controls an evaporator expansion valve, and terminates the control.

The process (A) may include: operating, by the controller, the pre-cooling mode according to an operation of a pre-cooling mode operating part by a manipulation or setting of a user before driving of the vehicle; operating, by the controller, the air conditioner; and operating, by the controller, a compressor.

In the operating, by the controller, of the compressor, the controller, according to the data detected from the data detector, may control revolutions per minute (RPM) of the compressor.

The process (B) may include: requesting, by the controller, cooling of the battery module according to the data detected from the data detector; and operating, by the controller, the battery chiller expansion valve so that an expanded refrigerant is supplied to a chiller.

In the operating, by the controller, of the battery chiller expansion valve, the controller may be configured to control an opening amount of the battery chiller expansion valve according to the data detected by the data detector.

The process (C) may include: determining, by the controller, whether the evaporator is frozen according to the data detected from the data detector; and in the determining, by the controller, of whether the evaporator is frozen, when the controller concludes that the evaporator is frozen, operating, by the controller, an evaporator thawing mode.

In the operating, by the controller, of the evaporator thawing mode, the controller may be configured to control at least one of the evaporator expansion valve, a blow motor, and an outside/inside air mode operating part.

The controller may stop an operation of the evaporator expansion valve.

The controller may intermittently operate the evaporator expansion valve.

The controller may increase the number of stages of the blow motor so that an amount of outside air passing through the evaporator may be increased.

The controller may operate an outside air circulation mode by controlling the outside/inside air mode operating part.

When the operating, by the controller, of the evaporator thawing mode is completed, the determining, by the controller, of whether the evaporator is frozen according to the data detected by the data detector may be returned to.

The process (C) may include in the determining, by the controller, of whether the evaporator is frozen, when it is determined that the evaporator is not frozen (that is, when a condition is not satisfied), operating, by the controller, the evaporator expansion valve and terminating the control.

The data detector may include: a pre-cooling mode operating part that is configured to operate according to a manipulation of a user; a battery temperature sensor that is configured to measure a temperature of a battery module; and an evaporator freezing detecting sensor that is configured to detect freezing of the evaporator.

According to the thermal management system control method for the vehicle according to the exemplary embodiment of the present invention as described above, it is possible to improve overall cooling performance by preventing a rapid temperature rise of a battery module by use of a refrigerant circulating in an air conditioner before track driving of a high performance electric vehicle.

Furthermore, according to the exemplary embodiment of the present invention, it is possible to secure driving stability by preventing an evaporator from freezing while an air conditioner is in an operation state during track driving of a vehicle and by efficiently cooling the battery module.

Furthermore, according to the exemplary embodiment of the present invention, it is possible to operate a battery module at optimal performance by efficiently controlling a temperature of the battery module, and it is possible to increase a total mileage of a vehicle through efficient management of the battery module.

Furthermore, according to the exemplary embodiment of the present invention, it is possible to improve durability and reliability of a battery module through efficient temperature control of the battery module, and it is possible to reduce maintenance costs, improving overall marketability of a vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a block diagram of a thermal management system to which a thermal management system control method for a vehicle according to various exemplary embodiments of the present invention is applied.

FIG. 2 illustrates a block diagram of a thermal management system control apparatus to which a thermal management system control method for a vehicle according to various exemplary embodiments of the present invention is applied.

FIG. 3 illustrates a control flowchart of a thermal management system control method for a vehicle according to various exemplary embodiments of the present invention.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Various exemplary embodiments of the present invention will hereinafter be described in detail with reference to the accompanying drawings.

Since the exemplary embodiment described in the specification and the configurations shown in the drawings are merely the most preferable embodiment and configurations of the present invention, they do not represent all of the technical ideas of the present invention, and it should be understood that various equivalents and modified examples, which may replace the embodiments, are possible when filing the present application.

To clearly describe the present invention, parts that are irrelevant to the description are omitted, and identical or similar constituent elements throughout the specification are denoted by the same reference numerals.

Since the size and thickness of each configuration shown in the drawings are arbitrarily shown for convenience of description, the present invention is not necessarily limited to configurations illustrated in the drawings, and in order to clearly illustrate several parts and areas, enlarged thicknesses are shown.

Moreover, throughout the specification, unless explicitly described to the contrary, the word “comprise” and variations such as “comprises” or “comprising” will be understood to imply the inclusion of stated elements but not the exclusion of any other elements.

Furthermore, terms such as “ . . . unit”, “ . . . means”, “ . . . part”, and “ . . . member” described in the specification mean a unit of a comprehensive configuration having at least one function or operation.

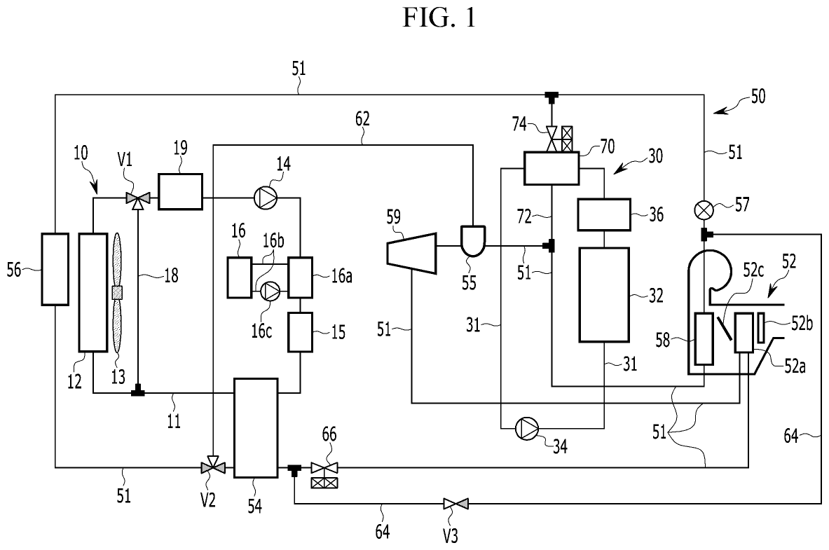

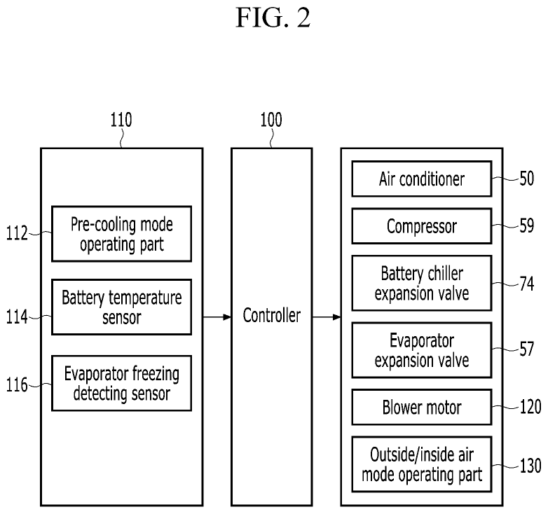

FIG. 1 illustrates a block diagram of a thermal management system to which a thermal management system control method for a vehicle according to various exemplary embodiments of the present invention is applied, and FIG. 2 is a block diagram of a thermal management system control apparatus to which a thermal management system control method for a vehicle according to various exemplary embodiments of the present invention is applied.

Referring to FIG. 1, a thermal management system control method for a vehicle according to various exemplary embodiments of the present invention is controlled by a controller 100, and it is applied to a thermal management system to be able to prevent a rapid temperature rise of a battery module 32 by use of a refrigerant circulating in an air conditioner 50 before track driving of a high performance electric vehicle, and to be able to secure driving stability by preventing an evaporator 58 from freezing while the air conditioner 50 is in an operation state.

Here, the thermal management system includes a cooling apparatus 10, a battery cooling apparatus 30, an air conditioner 50, and a battery chiller 70, as shown in FIG. 1.

First, the cooling apparatus 10 includes a radiator 12 connected to a coolant line 11 and a first water pump 14. The cooling apparatus 10 circulates a coolant in the first coolant line 11 through an operation of the first water pump 14 to cool an electrical component 15 and a motor 16.

The first radiator 12 is disposed at the front of the vehicle, and a cooling fan 13 is provided at the rear thereof, so that the coolant is cooled through an operation of the cooling fan 13 and heat-exchange with the outside air.

Here, the electrical component 15 may include a power control apparatus, an inverter, a power converter such as an on board charger (OBC), and an autonomous driving controller.

The power control apparatus or the inverter may heat up while driving, and the on board charger may heat up when charging the battery module 32.

The electrical component 15 configured as described above may be provided in the coolant line 11 to be cooled in a water-cooled manner.

That is, when the waste heat of the electrical component 15 is recovered in the heating mode of the vehicle, the heat generated from the power conversion apparatus such as the power control apparatus, the inverter, or the OBC may be recovered.

Meanwhile, the cooling apparatus 10 circulates a coolant in the coolant line 11 through an operation of the first water pump 14 to cool an oil cooler 16a that cools the electrical component 15 and the motor 16.

Here, the motor 16 is connected to the oil cooler 16a provided in the coolant line 11 through an oil line 16b, and an oil pump 16c may be provided in the oil line 16b.

That is, the oil cooler 16a may cool oil supplied to the motor 16 by use of a coolant supplied from the radiator 12.

The oil pump 16c may be selectively operated to supply the cooled oil to the motor 16 when cooling of the motor 16 is required.

Furthermore, the oil pump 16c may be operated when recovering the waste heat generated by the motor 16 in the heating mode of the vehicle.

That is, while the oil cooled by the oil cooler 16a cools the motor 16 through the oil line 16b, a temperature thereof is increased. The oil whose temperature has risen may increase the temperature of the coolant as it is cooled through heat-exchange with the coolant in the oil cooler 16a.

The waste heat generated from the motor 16 may be recovered through the operation as described above.

Meanwhile, a reservoir tank 19 is provided in the coolant line 11 between the radiator 12 and the first water pump 14. The coolant cooled by the first radiator 12 may be stored in the reservoir tank 19.

The cooling apparatus 10 configured as described above circulates a coolant in the coolant line 11 so that the coolant is supplied to the oil cooler 16a for cooling the electrical component 15 and the motor 16.

That is, the cooling apparatus 10 circulates the coolant cooled by the radiator 12 along the coolant line 11 through operation of the first water pump 14, cooling the electrical component 15 and the oil cooler 16a to not overheat.

On the other hand, in various exemplary embodiments of the present invention, it is referred to as an exemplary embodiment that there is one motor 16, but the present invention is not limited thereto, and there may be two motors 16 to correspond to a front wheel and a rear wheel.

When there are two motors 16, they may be disposed in parallel through a separate parallel line in the coolant line 11.

Meanwhile, a branch line 18 connected to the coolant line 11 between the radiator 12 and the first water pump 14 through the first valve V1 provided in the coolant line 11 between the radiator 12 and the first water pump 14 may be provided in the cooling apparatus 10.

One end portion of the branch line 18 may be connected to the coolant line 11 through the first valve V1, and the other end portion of the branch line 18 may be connected to the coolant line 11 between the radiator 12 and the first water pump 18.

The branch line 18 is selectively opened through operation of the first valve V1 when the coolant temperature is raised by absorbing the waste heat generated from the electrical component 15 and the motor 16. In the instant case, the coolant line 11 connected to the radiator 12 is closed through operation of the first valve V1.

In various exemplary embodiments of the present invention, the battery cooling apparatus 30 may include a battery module 32 and a second water pump 34 connected through a battery coolant line 31.

The battery module 32 supplies power to the electrical component 15 and the motor 16, and is formed to be cooled with a coolant flowing along the battery coolant line 31.

The battery module 32 may circulate the coolant therein through operation of the second water pump 34 provided in the battery coolant line 31.

Here, the first and second water pumps 14 and 34 may be electric water pumps.

In various exemplary embodiments of the present invention, the air conditioner 50 includes a heating, ventilation, and air conditioning (HVAC) module 52, a main heat exchanger 54, an accumulator 55, an evaporator expansion valve 57, an evaporator 58, and a compressor 59, which are connected thereto through a refrigerant line 51.

First, the HVAC module 52 includes an opening/closing door 52c which is connected thereto through the refrigerant line 51 and controls the external air passing through the evaporator 58 to selectively flow into an internal condenser 52a and an internal heater 52b according to the cooling, heating, and heating/dehumidifying modes of the vehicle.

That is, the opening/closing door 52c is opened so that the external air that has passed through the evaporator 58 flows into the internal condenser 52a and the internal heater 52b in the heating mode of the vehicle. In contrast, in the cooling mode of the vehicle, the opening/closing door 52c closes the internal condenser 52a side and the internal heater 52b side so that the external air cooled while passing through the evaporator 58 directly flows into the vehicle.

The main heat exchanger 54 is connected to the coolant line 51 so that the coolant passes through it, and is connected to the coolant line 11 so that the coolant circulating in the cooling apparatus 10 passes through it.

The main heat exchanger 54 may condense or evaporate the refrigerant through the heat-exchange with the coolant supplied through the coolant line 11 according to the vehicle mode. That is, the main heat exchanger 54 may be a water-cooled heat exchanger into which a coolant flows.

The main heat exchanger 54 configured as described above heat-exchanges the refrigerant supplied from the compressor 59 through the internal condenser 52a with the coolant supplied from the cooling apparatus 10. Through the present operation, the main heat exchanger 54 may lower a temperature of the refrigerant, and may increase an amount of condensation or evaporation.

In various exemplary embodiments of the present invention, the accumulator 55 is selectively supplied with the refrigerant discharged from the main heat exchanger 54 through a second valve V2 that operates according to the vehicle mode.

The accumulator 55 improves efficiency and durability of the compressor 59 by supplying only the gaseous refrigerant to the compressor 59.

On the other hand, the refrigerant line 51 between the main heat exchanger 54 and the evaporator 58 may be provided with a sub-condenser 56 for additionally condensing the refrigerant that has passed through the main heat exchanger 54.

The refrigerant that has passed through the main heat exchanger 54 may selectively flow into the sub-condenser 56 according to the operation of the second valve V2.

That is, the sub-condenser 56 is disposed in front of the radiator 12 to mutually heat-exchange the refrigerant flowing thereinto with the outside air.

Accordingly, when the main heat exchanger 54 condenses the refrigerant, the sub-condenser 56 further condenses the refrigerant condensed in the main heat exchanger 54, so that it may increase sub-cooling of the refrigerant, thus a coefficient of performance (COP), which is a coefficient of cooling capacity to required power of a compressor, may be improved.

In various exemplary embodiments of the present invention, the evaporator expansion valve 57 is provided in the refrigerant line 51 connecting the sub-condenser 56 and the evaporator 58. The evaporator expansion valve 57 receives the refrigerant passed through the sub-condenser 56 to expand it. The evaporator expansion valve 57 may be an electronic or mechanical expansion valve.

The compressor 59 is connected between the evaporator 58 and the main heat exchanger 54 through the refrigerant line 51. The compressor 59 may compress the gaseous refrigerant, and may supply the compressed refrigerant to the internal condenser 52a.

The air conditioner 50 configured as described above may further include a battery chiller expansion valve 74, a first bypass line 62, a heat exchanger expansion valve 66, and a second bypass line 64.

First, the battery chiller expansion valve 74 is provided in a refrigerant connection line 72 between the sub-condenser 56 and the battery chiller 70.

Here, the battery chiller expansion valve 74 is operated when cooling the battery module 30 by use of a refrigerant. The battery chiller expansion valve 74 may expand the refrigerant flowing through the refrigerant connection line 72 to flow into the battery chiller 70.

That is, the battery chiller expansion valve 74 expands the refrigerant condensed in and discharged from the sub-condenser 56 to flow it into the battery chiller 70 in a state of lowering the temperature thereof, so that the temperature of the coolant passing through the inside of the battery chiller 70 may be further reduced.

Accordingly, the coolant whose temperature is reduced while passing through the battery chiller 70 may flow into the battery module 32 to be more efficiently cooled.

In various exemplary embodiments of the present invention, the first bypass line 62 may connect the main heat exchanger 54 and the accumulator 55 through the second valve V2 so that the refrigerant that has passed through the main heat exchanger 54 may be selectively flowed into the compressor 59 through the accumulator 55.

That is, the second valve V2 may selectively open the first bypass line 62 according to the vehicle mode.

Here, the accumulator 55 may supply a gaseous refrigerant of the refrigerant supplied through the first bypass line 62 opened through operation of the second valve V2 to the compressor 59.

In various exemplary embodiments of the present invention, the heat exchanger expansion valve 66 may be provided in the refrigerant line 51 between the internal condenser 52a and the main heat exchanger 54.

The heat-exchanger expansion valve 66 may selectively expand the refrigerant flowing into the main heat exchanger 54 and the second bypass line 64 in the vehicle's heating and dehumidifying modes.

Furthermore, the second bypass line 64, so that some of the refrigerant that has passed through the internal condenser 52a, may selectively flow into the evaporator 58, may connect the refrigerant line 51 between the main heat exchanger 54 and the heat exchanger expansion valve 66 to the refrigerant line 51 between the evaporator expansion valve 57 and the evaporator 58.

Here, the second bypass line 64 may be provided with a third valve V3. The third valve V3 may selectively open the second bypass line 64 according to the vehicle mode.

That is, the battery chiller expansion valve 74 and the heat exchanger expansion valve 66 may be electronic expansion valves that selectively expand a refrigerant while controlling flow of the refrigerant.

Furthermore, the first and second valves V1 and V2 may be three-way valves which may distribute a flow rate, and the third valve V3 may be a two-way valve.

Furthermore, the battery chiller 70 is provided in the battery coolant line 31 so that the coolant passes therein, and it is connected to the coolant line 51 through the coolant connection line 72.

The battery chiller 70 may heat-exchange the coolant selectively introduced therein with the coolant supplied from the air conditioner 50 to control the temperature of the coolant. Here, the battery chiller 70 may be a water-cooled heat exchanger into which a coolant flows.

A heater 36 may be provided in the battery coolant line 31 between the battery module 32 and the battery chiller 70.

The heater 36 is turned on when the temperature of the battery module 32 is required to increase and heats the coolant circulated in the battery coolant line 31, flowing the coolant of the increased temperature to the battery module 32.

The heater 36 may be an electric heater that operates according to supplying of power.

The thermal management system configured as described above may be controlled by a thermal management system control apparatus as shown in FIG. 2, and the thermal management system control apparatus may include the controller 100 and a data detector 110.

Here, the data detector 110 may detect data on whether a pre-cooling mode of the vehicle is selected in the thermal management system, the temperature of the battery module 32, and whether the evaporator 58 is frozen.

The data detected by the data detector 110 is transmitted to the controller 100. The data detector 110 may include a pre-cooling mode operating part 112, a battery temperature sensor 114, and an evaporator freezing detecting sensor 116.

First, the pre-cooling mode operating part 112 may be operated by a user's operation or setting before track driving. When the pre-cooling mode operating part 112 is operated by the user, a signal corresponding thereto is transmitted to the controller 100.

Here, the pre-cooling mode operating part 112 may be applied as a switch or button structure provided inside the vehicle, or may be applied as an icon on a touch screen.

The battery temperature sensor 114 measures the temperature of the battery module 32 to transmit a signal corresponding thereto to the controller 100.

Furthermore, the evaporator freezing detecting sensor 116 detects whether the evaporator 58 is frozen and transmits the detected signal to the controller 100.

The controller 100 controls the air conditioner 50, the compressor 59, the evaporator expansion valve 57, the battery chiller expansion valve 74, a blow motor 110, or an outside/inside air mode operating part 120 so that a sudden temperature rise of the battery module 32 may be prevented during track driving of the electric vehicle based on the data detected by the data detector 110.

For the present purpose, the controller 100 may be implemented as at least one processor operating according to a predetermined program, and the predetermined program may include a series of instructions for performing respective steps included in an air conditioning system control method according to various exemplary embodiments of the present invention to be described later.

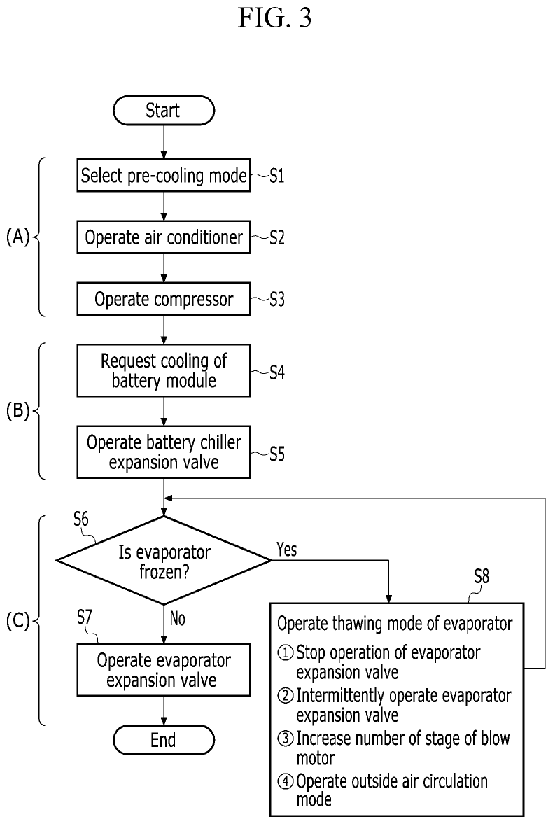

FIG. 3 illustrates a control flowchart of a thermal management system control method for a vehicle according to various exemplary embodiments of the present invention.

Referring to FIG. 3, a thermal management system control method for a vehicle according to various exemplary embodiments of the present invention includes: (A) a process in which the controller 100 checks whether a pre-cooling mode is selected based on the data detected by the data detector 110 before track driving of a vehicle and operates the air conditioner 50; (B) a process in which the controller 100, when the process (A) is completed, operates the battery chiller expansion valve 74 to cool the battery module 32 according to the data detected from the data detector 110; and (C) a process in which the controller 100, when the process (B) is completed, determines whether the evaporator 58 is frozen to thaw the evaporator 58 or control the evaporator expansion valve 74 and then terminates the controlling.

In various exemplary embodiments of the present invention, the process (A) may include the following steps.

First, the controller 100 selects the pre-cooling mode according to the operation of the pre-cooling mode operating part 112 by the user's operation or setting before the vehicle's track driving (S1).

Accordingly, the controller 100 operates the air conditioner 50 according to the data detected from the data detector 110 (S2).

When step S2 of operating the air conditioner 50 is completed, the controller 100 operates the compressor 59 (S3).

In step S3 of the controller 100 operating the compressor 59, the controller 100 may control revolutions per minute (RPM) of the compressor 59 according to the data detected from the data detector 110.

Accordingly, the controller 100 may control an entire flow rate of the refrigerant circulating through the air conditioner 50.

As described above, when the process (A) is completed, the controller 100 may perform the process (B).

In the process (B), the controller 100 requests cooling of the battery module 32 according to the data detected from the data detector 110 (S4).

Here, the controller 100 may request cooling of the battery module 32 according to an output signal outputted from the battery temperature sensor 114.

When the cooling request of the battery module 32 is completed, the controller 100 operates the battery chiller expansion valve 74 so that an expanded refrigerant is supplied to the battery chiller 70 (S5).

That is, the controller 100 may operate the battery chiller expansion valve 74 for expanding the refrigerant supplied to the battery chiller 70 to efficiently cool the battery module 32 by use of the coolant heat-exchanged with the refrigerant.

Here, the controller 100 may control an opening amount of the battery chiller expansion valve 74 based on the data detected by the data detector 110.

That is, the controller 100 may control the opening amount of the battery chiller expansion valve 74 according to the signal detected by the battery temperature sensor 114, adjusting the flow rate of the expanded refrigerant flowing into the battery chiller 70.

When step S5 of operating the battery chiller expansion valve 74 is completed, the controller 100 performs the process (C).

In the process (C), the controller 100 determines whether the evaporator 58 is frozen according to the data detected by the data detector 110 (S6).

That is, the controller 100 may determine whether the evaporator 58 is frozen according to a signal detected by the evaporator freezing detecting sensor 116.

In step S6 of determining whether the evaporator 58 is frozen, when it is determined that the evaporator 58 is not frozen (that is, when the condition is not satisfied), the controller 100 continuously operates the evaporator expansion valve 74 (S7), and ends the control.

In contrast, in step S6 of determining whether the evaporator 58 is frozen, and when it is determined that the evaporator 58 is frozen (that is, when the condition is satisfied), the controller 100 operates a thawing mode of the evaporator (S8).

In step S8 of operating the thawing mode of the evaporator, the controller 100 may control at least one of the evaporator expansion valve 74, the blow motor 110, and the outside/inside air mode operating part 120.

First, when the controller 100 controls the evaporator expansion valve 74, the controller 100 may stop the operation of the evaporator expansion valve 55, or may intermittently operate the evaporator expansion valve 57.

That is, when the operation of the evaporator expansion valve 57 is stopped or operated intermittently, the refrigerant is not supplied to the evaporator 58 or is intermittently supplied thereto, so that it is possible to increase the temperature of the evaporator 58 while preventing the temperature thereof from being lowered.

In various exemplary embodiments of the present invention, when the controller 100 controls the blow motor 110, the controller 100 may increase the number of stages of the blow motor 110 so that an airflow amount of the outside air passing through the evaporator 58 is increased.

Accordingly, the flow rate of the outside air passing through the evaporator 58 is increased, and the evaporator 58 may be thawed through the heat-exchange with the increased flow rate of the outside air.

On the other hand, the blow motor 110 may be a blower provided inside the HVAC module 52 to flow outside air into the interior of the vehicle.

Finally, when the controller 100 controls the outside/inside air mode operating part 120, the controller 100 may control the outside/inside air mode operating part 120 to operate the outside air circulation mode.

Accordingly, outside air is introduced into the interior of the vehicle, and the outside air may thaw the evaporator 58 through heat-exchange while passing through the evaporator 58.

On the other hand, in various exemplary embodiments of the present invention, in step S8 of operating the evaporator thawing mode, it is referred to as an exemplary embodiment that the controller 100 controls at least one of the evaporator expansion valve 74, the blow motor 110, and the outside/inside air mode operating part 120, but the present invention is not limited thereto, and the controller 100 may control two or all of the evaporator expansion valve 74, the blow motor 110, and the outside/inside air mode operating part 120.

Through these operations, when step S8 of operating the evaporator thawing mode is completed, the controller 100 may return to step S6 of determining whether the evaporator 58 is frozen to repeatedly perform respective steps described above.

That is, the controller 100, while repeatedly performing respective steps as described above, efficiently controls the flow rate of the refrigerant supplied to the battery chiller 70 through the operation control of the cooling apparatus 10 and the battery cooling apparatus 30, and the control of the battery chiller expansion valve 74, delaying a sudden increase in the temperature of the battery module 32 during track driving.

Furthermore, the controller 100 determines whether the evaporator 58 is frozen, and controls at least one of the evaporator expansion valve 57, the blow motor 110, and the outside/inside air mode operating part 120, rapidly thawing the frozen evaporator 58.

As described above, the thermal management system control method for the vehicle according to the exemplary embodiment of the present invention delays the rapid increase in the temperature of the battery module 32 by the pre-cooling mode selected before the track driving of the vehicle while performing respective steps described above, and rapidly thaws the evaporator 58, maximally realizing the performance of the vehicle during the track driving, and improving driving stability.

When the thermal management system control method for the vehicle according to the exemplary embodiment of the present invention as described above is applied, it is possible to improve overall cooling performance by preventing a rapid temperature rise of the battery module 32 by use of the refrigerant circulating the air conditioner 50 before the track driving of the high performance electric vehicle.

Furthermore, the present invention prevents freezing of the evaporator 58 in the state in which the air conditioner 50 is operated during the track driving of the vehicle, and efficiently cools the battery module 32, securing driving stability.

Furthermore, according to various exemplary embodiments of the present invention, the battery module 32 may operate in an optimum performance state by efficiently controlling the temperature of the battery module 50, and the total traveling distance of the vehicle may be increased through the efficient management of the battery module 32.

Furthermore, the present invention may improve the durability and reliability of the battery module 32 and the evaporator 58 through efficient temperature control of the battery module 32, and may reduce maintenance costs, improving the overall marketability of the vehicle.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A method of controlling a thermal management system for a vehicle, the method comprising:
(A) step of determining, by a controller, whether a pre-cooling mode is selected according to data detected from a data detector before track driving of the vehicle, and operating, by the controller, an air conditioner of the thermal management system;
(B) step of operating, by the controller, when the (A) step is completed, a battery chiller expansion valve of the thermal management system to cool a battery module of the thermal management system according to the data detected from the data detector; and
(C) step of determining, by the controller, when the step (B) is completed, whether an evaporator of the thermal management system is frozen and then thawing the evaporator or controlling an evaporator expansion valve of the thermal management system, and terminating the controlling.

2. The method of claim 1, wherein the (A) step includes:
operating, by the controller, the pre-cooling mode according to an operation of a pre-cooling mode operating part of the thermal management system in response to manipulation or setting of a user before driving of the vehicle;
operating, by the controller, the air conditioner; and
operating, by the controller, a compressor of the thermal management system.

3. The method of claim 2, wherein in the operating, by the controller, of the compressor,
the controller is configured to control revolutions per minute (RPM) of the compressor, according to the data detected from the data detector.

4. The method of claim 1, wherein the (B) step includes:
requesting, by the controller, cooling of the battery module according to the data detected from the data detector; and
operating, by the controller, the battery chiller expansion valve so that an expanded refrigerant is supplied to a chiller of the thermal management system.

5. The method of claim 4, wherein
in the operating, by the controller, of the battery chiller expansion valve,
the controller is configured to control an opening amount of the battery chiller expansion valve according to the data detected by the data detector.

6. The method of claim 1, wherein the (C) step includes:
determining, by the controller, whether the evaporator is frozen according to the data detected from the data detector; and
in the determining of whether the evaporator is frozen, when the controller concludes that the evaporator is frozen, operating, by the controller, an evaporator thawing mode.

7. The method of claim 6, wherein
in the operating, by the controller, of the evaporator thawing mode,
the controller is configured to control at least one of the evaporator expansion valve, a blow motor, and an outside/inside air mode operating part of the thermal management system.

8. The method of claim 7, wherein the controller is configured to stop an operation of the evaporator expansion valve.

9. The method of claim 7, wherein the controller is configured to selectively operate the evaporator expansion valve.

10. The method of claim 7, wherein the controller is configured to increase a number of stages of the blow motor so that an amount of outside air passing through the evaporator is increased.

11. The method of claim 7, wherein the controller is configured to operate an outside air circulation mode by controlling the outside/inside air mode operating part of the thermal management system.

12. The method of claim 6, wherein
when the operating, by the controller, of the evaporator thawing mode is completed,
the determining, by the controller, of whether the evaporator is frozen according to the data detected by the data detector is returned to.

13. The method of claim 6, wherein the (C) step includes:
in the determining, by the controller, of whether the evaporator is frozen, when the controller concludes that the evaporator is not frozen, operating, by the controller, the evaporator expansion valve, and terminating the controlling.

14. The method of claim method of claim 1, wherein the data detector includes:
a pre-cooling mode operating part that is configured to operate in response to a manipulation of a user;
a battery temperature sensor that is configured to measure a temperature of the battery module; and
an evaporator freezing detecting sensor that is configured to detect freezing of the evaporator.
